(19) United States
(12) Patent Application Publication
(10) Pub. No.: US 2017/0168203 A1
(43) Pub. Date: Jun. 15, 2017

(54) FLEXIBLE COLOR FILTER AND METHOD OF MANUFACTURING THE SAME

(71) Applicant: Samsung Display Co., Ltd., Yongin-si (KR)

(72) Inventors: Yunseon DO, Yongin-si (KR); Jaejoong KWON, Yongin-si (KR); Chio CHO, Yongin-si (KR)

(21) Appl. No.: 15/176,658

(22) Filed: Jun. 8, 2016

(30) Foreign Application Priority Data
Dec. 15, 2015 (KR) 10-2015-0179197

(51) Int. Cl. G02B 5/22; G02B 7/00; G02B 5/20

(52) U.S. Cl. CPC G02B 5/22; G02B 5/201; G02B 7/006

(57) ABSTRACT

A flexible color filter includes a flexible film including a first side and a second side opposite to the first side, the flexible film including first concave portions disposed in the first side of the flexible film, and first color conversion portions respectively disposed in the first concave portions, in which the flexible film includes a first pixel area and a second pixel area adjacent to the first pixel area, first concave portions are disposed in the first pixel area, and each of the first color conversion portions includes a first metal particle.

### CROSS-REFERENCE TO RELATED APPLICATION

This application claims priority from and the benefit of Korean Patent Application No. 10-2015-0179197, filed on Dec. 15, 2015, which is hereby incorporated by reference for all purposes as if fully set forth herein.

### BACKGROUND

Field

Exemplary embodiments relate to a flexible color filter and a method of manufacturing the same.

Discussion of the Background

According to the development of display technologies, a flexible display device, which may be foldable or rollable, has been researched and developed. In addition, a stretchable display device, the shape of which may be changed into various shapes, has been actively researched and developed.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a flexible color filter and a method of manufacturing the same.

Additional aspects will be set forth in the detailed description which follows, and, in part, will be apparent from the disclosure, or may be learned by practice of the inventive concept.

According to an exemplary embodiment of the present invention, a flexible color filter includes a flexible film including a first side and a second side opposite to the first side, the flexible film including first concave portions disposed in the first side of the flexible film, and first color conversion portions respectively disposed in the first concave portions, in which the flexible film includes a first pixel area and a second pixel area adjacent to the first pixel area, first concave portions are disposed in the first pixel area, and each of the first color conversion portions includes a first metal particle.

According to an exemplary embodiment of the present invention, a method of manufacturing a flexible color filter includes preparing a flexible film including a first side and a second side opposite to the first side, the flexible film including a first pixel area and a second pixel area, forming first concave portions in the first side of the flexible film in the first pixel area, and forming first color conversion portions in the first concave portions, respectively, each of the first color conversion portions comprising a first metal particle.

The foregoing general description and the following detailed description exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a cross-sectional view illustrating a display device according to an exemplary embodiment of the present invention.

FIG. 2 and FIG. 3A are cross-sectional views illustrating a method of manufacturing a flexible color filter, according to an exemplary embodiment of the present invention.

FIG. 3B is a plan view illustrating a pixel area of FIG. 3A.

FIG. 4, FIG. 5, FIG. 6, and FIG. 7 are cross-sectional views illustrating a method of manufacturing the flexible color filter after the operation of FIG. 3A is performed.

FIG. 8 is a cross-sectional view illustrating a bent state of the flexible color filter of FIG. 7.

FIG. 9 is a cross-sectional view illustrating a flexible color filter according to an exemplary embodiment of the present invention.

FIG. 10, FIG. 11, FIG. 12, FIG. 13, FIG. 14, and FIG. 15 are cross-sectional views illustrating a method of manufacturing a flexible color filter according to an exemplary embodiment of the present invention.

FIG. 16 is a cross-sectional view illustrating a flexible color filter according to an exemplary embodiment of the present invention.

FIG. 17 is a cross-sectional view illustrating a display device according to an exemplary embodiment of the present invention.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another elements) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

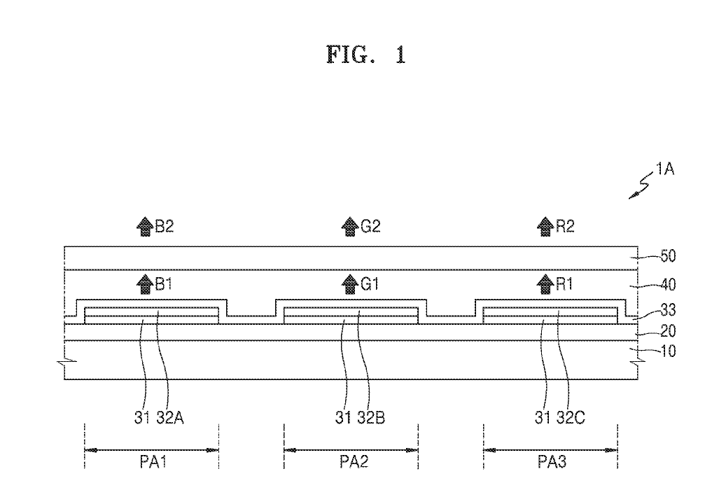

FIG. 1 is a cross-sectional view illustrating a display device according to an exemplary embodiment of the present invention.

Retelling to FIG. 1, the display device 1A may include a substrate 10, on which a display element is disposed for each pixel area PA1, PA2, and PA3. The display device 1A according to the present exemplary embodiment may be an organic light-emitting diode display device. The display element may include an organic light-emitting diode including a pixel electrode 31, an opposite electrode 33, and a light-emitting layer 32A between the opposite electrode 33 and the pixel electrode 31. The pixel electrode 31 of each pixel area PA1, PA2, or PA3 may be electrically connected to a pixel circuit (not shown) of a circuit layer 20.

An encapsulation layer 40 is disposed on the opposite electrode 33 and may protect the organic light-emitting diode. For example, the encapsulation layer 40 may have a multi-layer structure, in which an organic layer and an inorganic layer are alternately stacked, and protects the organic light-emitting diode from impurities and moisture.

A flexible color filter 50 is disposed on the encapsulation layer 40. An extremely small amount of external light incident onto the flexible color filter 50 may be reflected therefrom, which may improve external light visibility. Accordingly, the flexible color filter 50 may replace a high-priced polarizer.

The flexible color filter 50 may improve color purity of light emitted from the respective pixel areas PA1, PA2, and PAS. For example, blue light B1, green light G1, and red light R1, which are emitted from the corresponding pixel areas PA1, PA2, and PA3 of the organic light-emitting diode, may be converted into blue light B2, green light G2, and red light R2, by which color purities thereof are improved by passing through the flexible color filter 50.

According to an exemplary embodiment of the present invention, light emitted from the organic light-emitting diode of each pixel area PA1, PA2, or PA3 may be white color light, and the white color light may be converted into blue light B2, green light G2, or red light R2 after passing through the flexible color filter 50. Hereinafter, for convenience of description, the pixel areas PA1, PA2, and PA3 will be described as corresponding to the blue color pixel, green color pixel, and red color pixel, respectively.

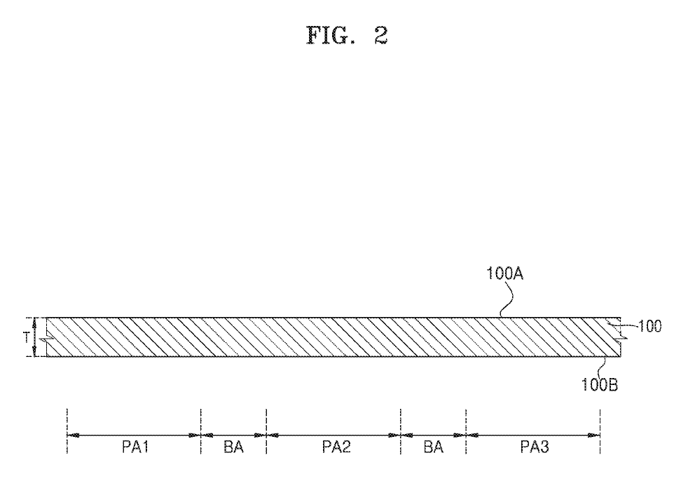

A flexible color filter will be described in more detail with reference to FIGS. 2 through 15.

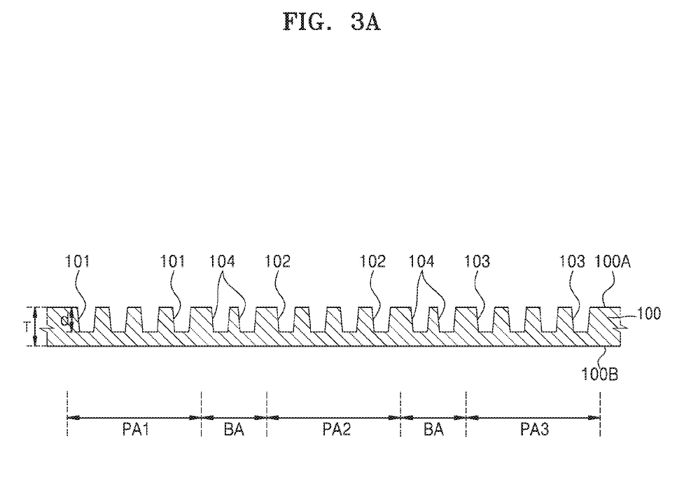

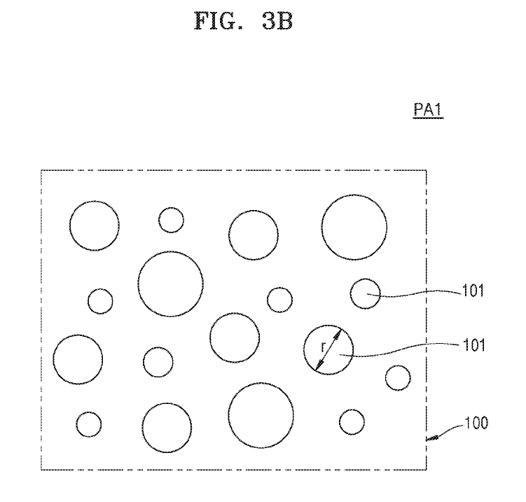

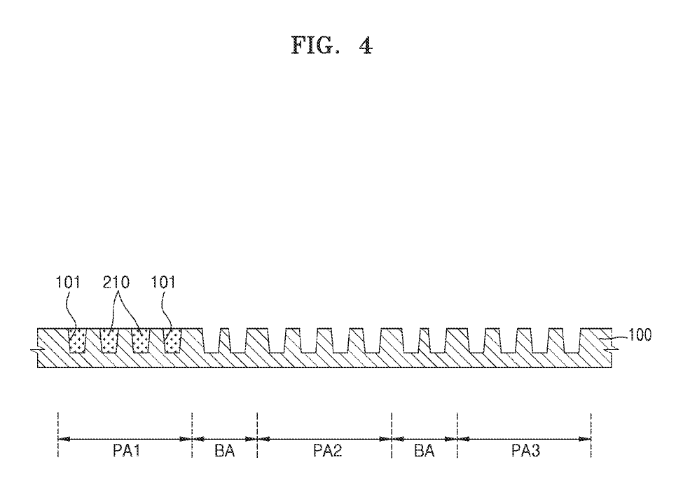

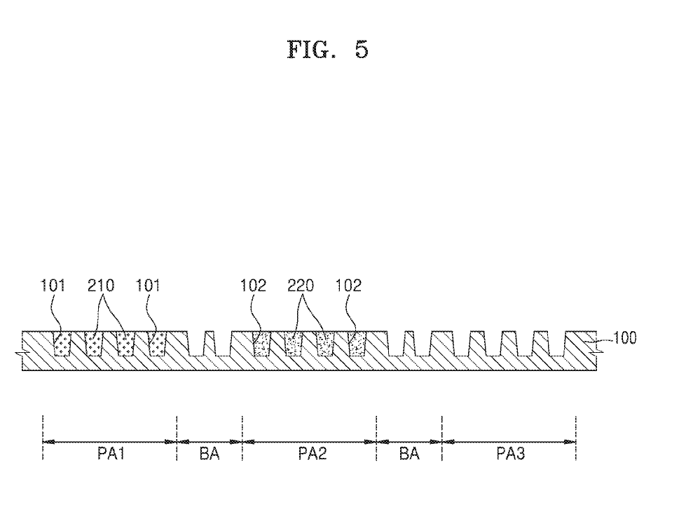

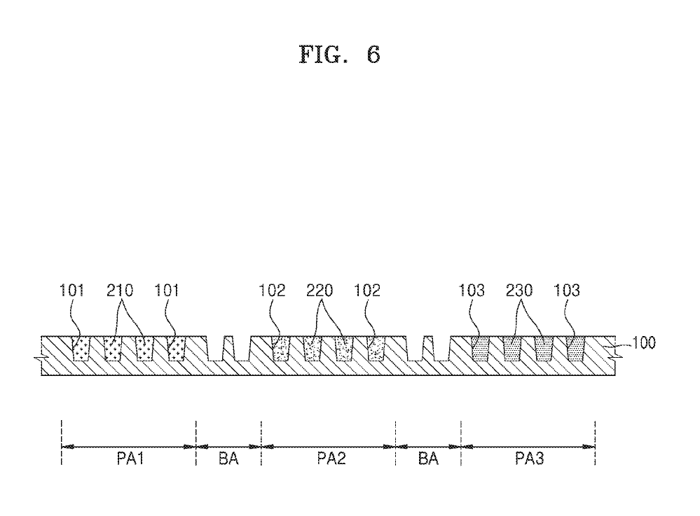

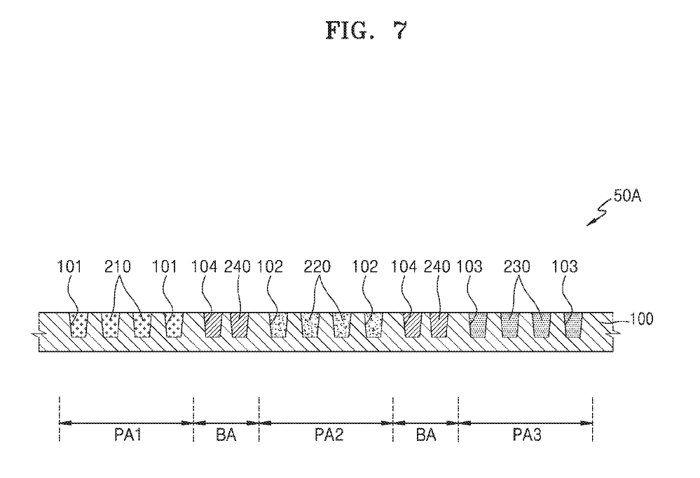

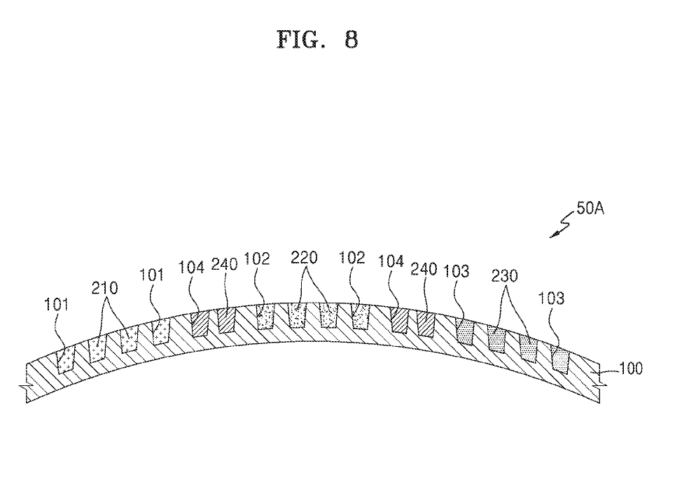

FIGS. 2, 3A, 4, 6, and 7 are cross-sectional views illustrating a method of manufacturing a flexible color filter according to an exemplary embodiment of the present invention. FIG. 3B is a plan view illustrating a pixel area, for example, a first pixel area of FIG. 3A. FIG. 8 is a cross-sectional view illustrating a bent state of the flexible color filter of FIG. 7.

Referring to FIG. 2, a flexible film 100 including a first side 100A and a second side 100B opposite to the first side 100A is prepared. The flexible film 100 may include a first pixel area PA1, a second pixel area. PA2, a third pixel area PAS, and a light blocking area BA disposed between the adjacent pixel areas PA1, PA2, and PAS.

The flexible film 100 may include a transparent resin material, such as polyethylene terephthalate (PET), polycarbonate (PC), and polyimide (PI). A thickness “T” of the flexible film 100 may be in a range from about 1 μm to about 1000 μm, and, for example, may be about 50 μm.

Referring to FIGS. 3A and 3B, concave portions are formed in the flexible film 100. First concave portions 101 corresponding to the first pixel area PA1, second concave portions 102 corresponding to the second pixel area PA2, third concave portions 103 corresponding to the third pixel area PA3, and one or more fourth concave portions (light blocking concave portions) 104 corresponding to the light blocking area BA may be formed by substantially the same operation. The first to fourth concave portions 101, 102, 103, and 104 may be island types, which are separated from each other.

The first to fourth concave portions 101, 102, 103, and 104 are formed in concave shapes in a first direction (or thickness direction) from the first side 100A of the flexible film 100 toward the opposite side, that is, the second side 100B of the flexible film 100. The first to fourth concave portions 101, 102, 103, and 104 may be formed by, for example, an ion beam process or an etching process.

Diameters “r” of the first to fourth concave portions 101, 102, 103, and 104 may be randomly formed, and depths “d” of the first to fourth concave portions 101, 102,103, and 104 may be less than the thickness “T” of the flexible film 100. Referring to FIG. 313, for example, diameters “r” of the first concave portions 101 in the first pixel area PM may be in random. According to an exemplary embodiment, the diameters “r” of the first to fourth concave portions 101, 102, 103, and 104 may be equal to or less than about 10 μm. For example, the diameters “r” of the first to fourth concave portions 101, 102, 103, and 104 may be in a range from about 0.01 μm to about 10 μm.

Arrangement of the first to fourth concave portions 101, 102, 103, and 104 may be irregular. For example, the number of first to fourth concave portions 101, 102, 103, and 104 per unit area (e.g., 1 cm²) may be equal to or more than about 1 billion. By irregularly arranging the first to fourth concave portions 101, 102, 103, and 104, a process restriction or burden for forming the first to fourth concave portions 101, 102, 103, and 104 may be reduced, and a defect ratio thereof may be decreased. Moreover, when defects occur while forming the first to fourth concave portions 101, 102, 103, and 104, a repair process may be easily performed, since there is substantially low design restriction on the arrangement of the first to fourth concave portions 101, 102, 103, and 104.

Referring to FIG. 4, first color conversion portions 210 are formed within the first concave portions 101 corresponding to the first pixel area PA1. Since the first concave portions 101 are island types that are separated from each other, first color conversion portions 210 formed within the corresponding first concave portions 101 are also island types, and thus, are separated from each other.

Each of the first color conversion portions 210 may include first metal particles. The first metal particles may be nanoscale metal particles. Light incident onto the first color conversion portions 210 may be converted into blue light, for example, according to a surface plasmon phenomenon of the first metal particles. The first metal particles may include at least one of gold (Au), silver (Ag), and aluminum (Al). The first metal particles may have various shapes, for example, a sphere shape, an ellipsoidal shape, and a rod shape.

The first metal particles are disposed within the first concave portions 101 by being dispersed in an organic solvent. The first color conversion portions 210 may be formed by using a slot die coating process, a gap coating process, an air knife coating process, a screen printing process, or an inkjet printing process.

According to an exemplary embodiment of the present invention, the first color conversion portions 210 may further include quantum dots. The quantum dots may include a core structure or a core-shell structure. The quantum dots may include a core including at least one of cadmium sulfide (CdS), cadmium selenide (CdSe), cadmium telluride (CdTe), zinc sulfide (ZnS), zinc selenide (ZnSe), indium arsenide (InAs), zinc selenide (ZnSe), zinc oxide (ZnO), zinc telluride (ZnTe), indium phosphide (InP), gallium phosphide (GaP), indium gallium nitride (InGaN), and indium nitride (InN). The quantum dots may alternatively include the core and a shell surrounding the core, and the shell may include at least one of zinc sulfide (ZnS), zinc selenide (ZnSe), gallium phosphide (GaP), and gallium nitride (GaN).

Referring to FIG. 5, second color conversion portions 220 are formed within the second concave portions 102 corresponding to the second pixel area PA2. Since the second concave portions 102 are island types that are separated from each other, the second color conversion portions 220 formed within the corresponding second concave portions 102 are also island types, and thus, are separated from each other.

Each of the second color conversion portions 220 may include second metal particles. The second metal particles may be nanoscale metal particles. Light incident onto the second color conversion portions 220 may be converted into green light, for example, according to a surface plasmon phenomenon of the second metal particles. The second metal particles are different from the first metal particles at least in one of the size and shape thereof, and thus, light incident onto the second color conversion portions 220 may be converted into light having different wavelength bands. The second metal particles may include at least one of Au, Ag, and Al. The second metal particles may have various shapes, for example, a sphere shape, an ellipsoidal shape, and a rod shape.

The second metal particles are disposed within the second concave portions 102 by being dispersed in an organic solvent. The second color conversion portions 220 may be formed by using a slot die coating process, a gap coating process, an air knife coating process, a screen printing process, or an inkjet printing process.

According to an exemplary embodiment of the present invention, the second color conversion portions 220 may further include quantum dots. The quantum dots may include a core structure or a core-shell structure. The material of the quantum dots of the second color conversion portions 220 may be substantially the same as those of the quantum dots of the first color conversion portions 210. The quantum dots of the second color conversion portions 220 are different from quantum dots of the first color conversion portions 210 in size.

Referring to FIG. 6, third color conversion portions 230 are formed within the third concave portions 103 corresponding to the third pixel area PA3. Since the third concave portions 103 are island types that are separated from each other, the third color conversion portions 230 formed within the corresponding third concave portions 103 are also island types, and thus, are separated from each other.

The third color conversion portions 230 may include third metal particles. The third metal particles may be nanoscale metal particles. Light incident onto the third color conversion portions 220 may be converted into red light, for example, according to a surface plasmon phenomenon of the third metal particles. The third metal particles are different from the first and/or second metal particles in at least one of the size and shape thereof, and thus, light incident onto the third color conversion portions 230 may be converted into light having different wavelength bands. The third metal particles may include at least one of Au, Ag, and Al. The third metal particles may have various shapes, for example, a sphere shape, an ellipsoidal shape, and a rod shape.

The third metal particles are disposed within the third concave portions 103 by being dispersed in an organic solvent. The third color conversion portions 230 may be formed by using a slot die coating process, a gap coating process, an air knife coating process, a screen printing process, or an inkjet printing process.

According to an exemplary embodiment of the present invention, the third color conversion portions 230 may further include quantum dots. The quantum dots may include a core structure or a core-shell structure. The material of the quantum dots of the third color conversion portions 220 may be substantially the same as those of the quantum dots of the first color conversion portions 210 and the second color conversion portions 220. The quantum dots of the third color conversion portions 230 are different from quantum dots of the first color conversion portions 210 and the second color conversion portions 220 in size.

Referring to FIG. 7, one or more light blocking portions 240 are formed within the fourth concave portion of the light blocking area BA. The light blocking portions 240 may include carbon black or a mixture of the first, second, and third metal particles. The light blocking portions 240 may be formed by using a slot die coating process, a gap coating process, an air knife coating process, a screen printing process, or an inkjet printing process.

As illustrated in FIG. 7, since the first to third color conversion portions 210, 220, and 230 disposed within the flexible film 100, the flexible color filter 50A may have substantially the same thickness as the flexible film 100. Since the first to fourth concave portions 101, 102, 103, and 104 are formed within the flexible film 100, the flexible color filter 50A may be easily bendable as illustrated in FIG. 8.

As the flexible color filter 50A performs color conversion by using metal particles therein, degradation of color reproducibility may be prevented. In a color filter that utilizes a pigment or a dye, when the pigment or dye is exposed to light emitted from the organic light-emitting diode or heat generated by light for a long period of time, the performance of the pigment or dye may be degraded.

According to the exemplary embodiments of the present invention, since the color conversion is performed by using metal particles having excellent heat resistance and light-fastness, the color reproducibility may be prevented from degrading when the display device is used for a longer period of time.

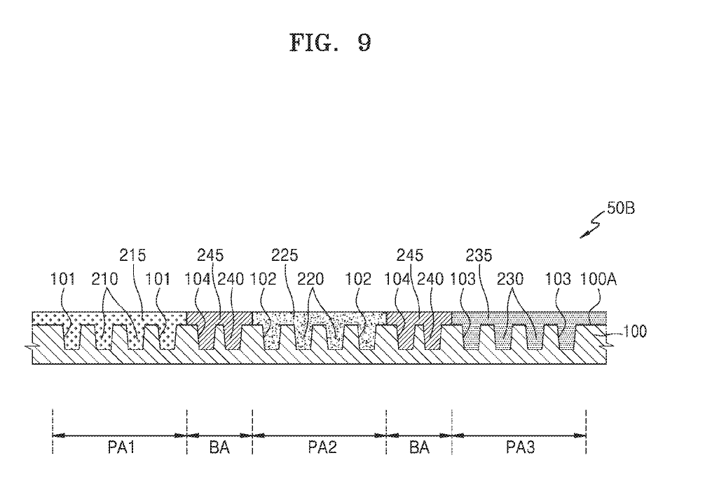

FIG. 9 is a cross-sectional view illustrating a flexible color filter 50B according to an exemplary embodiment of the present invention.

Referring to FIG. 9, the flexible color filter 50B is similar as the flexible color filter 50A of FIGS. 2 to 8, except for first, second, and third extended color conversion portions 215, 225, and 235. Therefore, repeated descriptions of the substantially similar elements will be omitted, and the differences will be explained hereinafter.

In the first pixel area PA1, the first color conversion portions 210 are disposed within the corresponding first concave portions 101, and a first extended color conversion portion 215 is disposed on the first side 100A of the flexible film 100. The first extended color conversion portion 215 connects the first color conversion portions 210 to each other.

The first extended color conversion portion 215 may include the same material as the first color conversion portions 210. The first extended color conversion portion 215 may be formed in the process of forming the first color conversion portions 210. For example, the first extended color conversion portion 215 may be formed together with the first color conversion portions 210.

In the second pixel area PA2, the second color conversion portions 220 are disposed within the corresponding second concave portions 102, and the second extended color conversion portion 225 is disposed on the first side 100A of the flexible film 100. The second extended color conversion portion 225 connects the second color conversion portions 220 to each other. The second extended color conversion portion 225 may include the same material as the second color conversion portions 220. The second extended color conversion portion 225 may be formed together with the second color conversion portions 22.0 during a process of forming the second color conversion portions 220.

In the third pixel area PA3, the third color conversion portions 230 are disposed within the corresponding third concave portions 103, and the third extended color conversion portion 235 is disposed on the first side 100A of the flexible film 100. The third extended color conversion portion 235 connects the third color conversion portions 230 to each other. The third extended color conversion portion 235 may include the same material as the third color conversion portions 230. The third extended color conversion portion 235 may be formed together with the third color conversion portions 230 during a process of forming the third color conversion portions 230.

In the light blocking area BA of the flexible color filter 50B, an extended light blocking portion 245 may be disposed on the first side 100A of the flexible film 100, and connect the light blocking portions 240 to each other, which are disposed in the light blocking area BA and are separated from each other. The extended light blocking portion 245 may include the same material as the light blocking portions 240. The extended light blocking portion 245 may be formed together with the light blocking portions 240 during a process of forming the light blocking portions 240.

Since the flexible color filter 50B according to the present invention includes the first, second, and third extended color conversion portions 215, 225, and 235, light passing through a bulk of the flexible film 100 between the first to third concave portions 101, 102, and 103, that is, light which is not converted by the first, second, and third color conversion portions 210, 220, and 230, may be prevented from being externally visible. More particularly, the light that is not converted by the first, second, and third color conversion portions 210, 220, and 230, is converted by the corresponding first to third extended color conversion portions 215, 225, and 235, and thus, color purity may be improved.

Since the flexible color filter 50B includes the first to third color conversion portions 210, 220, and 230 within the flexible film 100, the flexible color filter 50B may have a thickness similar to a thickness of the flexible film 100. The flexible color filter 50B may be easily bendable as illustrated in FIG. 8. Moreover, the flexible color filter 50B may perform the color conversion by using metal particles having excellent heat resistance and light-fastness, which may prevent degradation of the color reproducibility, when the display device is used for a longer period of time.

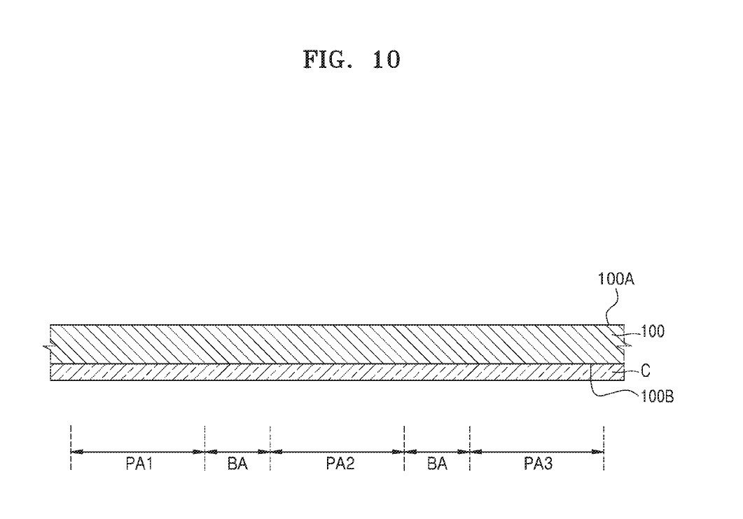

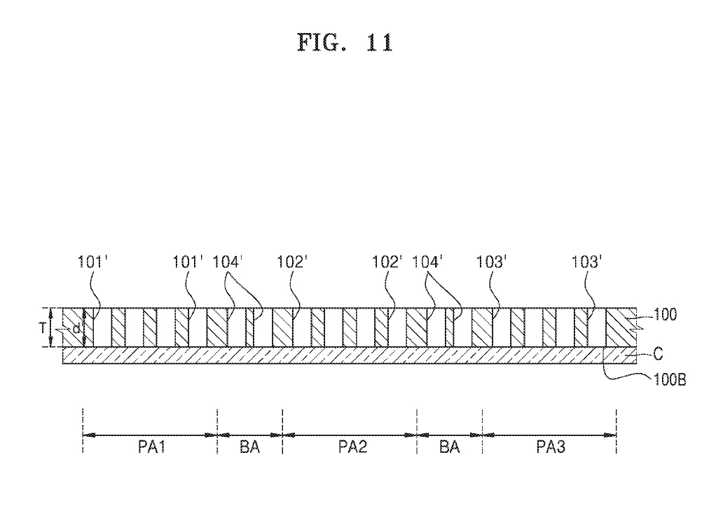

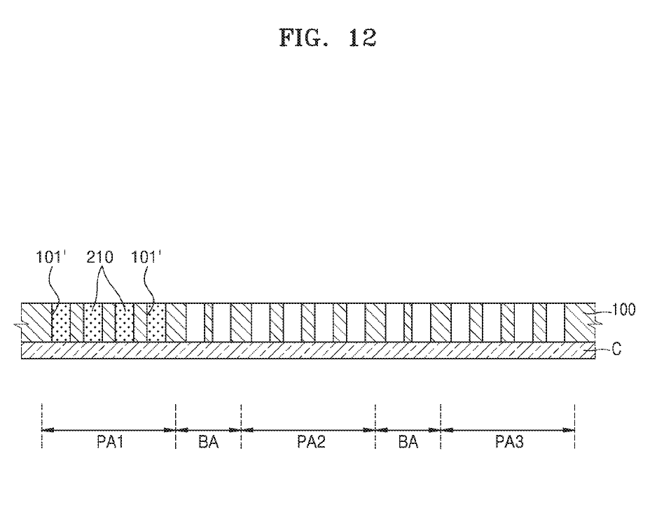

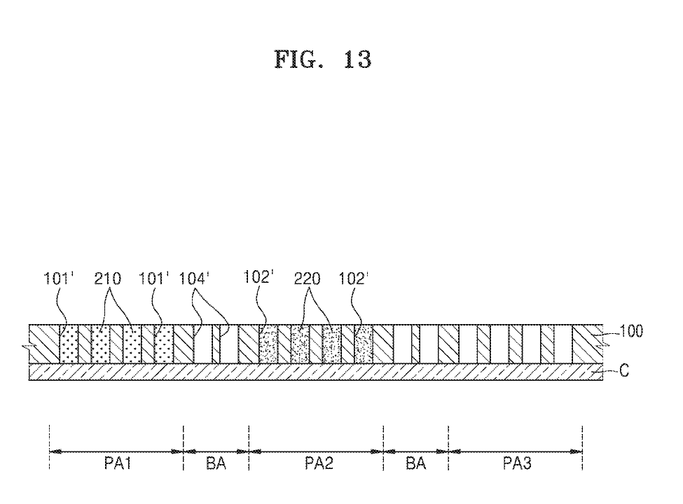

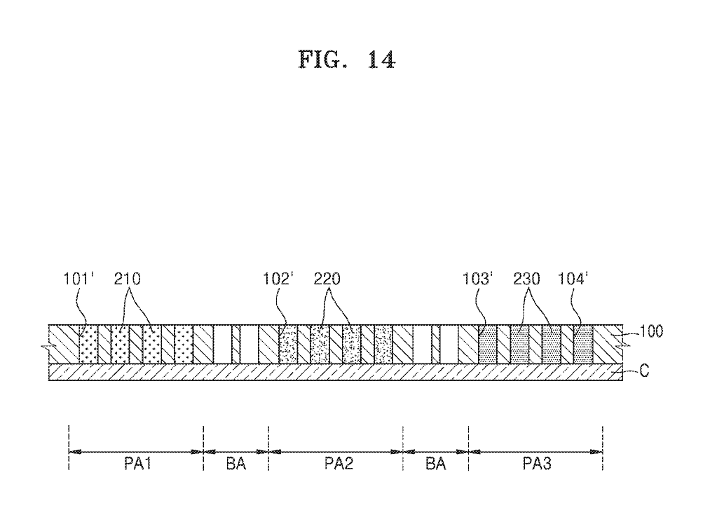

FIGS. 10 to 15 are cross-sectional views illustrating a method of manufacturing a flexible color filter 50C according to an exemplary embodiment of the present invention.

Referring to FIG. 10, a flexible film 100 is prepared on a carrier substrate C. The flexible film 100 includes a first side 100A and a second side 100B opposite to the first side 100A, and the carrier substrate C is arranged to contact the second side 100B of the flexible film 100. The flexible film 100 includes a first pixel area PA1, a second pixel area PA2, a third pixel area PA3, and a light blocking area BA between the adjacent pixel areas PA1, PA2, and PA3.

The carrier substrate C may be a substrate having weak adhesiveness. The carrier substrate C may include a glass material or a plastic material. The flexible film 100 may include a transparent resin material, such as PET, PC, and PI. The flexible film 100 may have a thickness from about 1 μm to 1000 μm, for example, a thickness of 50 μm.

Referring to FIG. 11, concave portions are formed in the flexible film 100. First concave portions 101′ corresponding to the first pixel area. PA1, second concave portions 102′ corresponding to the second pixel area PA2, third concave portions 103′ corresponding to the third pixel areas PA3, and fourth concave portions 104′ corresponding to the light blocking area BA may be formed together by the same process. The first to fourth concave portions 101′, 102′, 103′, and 104′ may be island types separated from one another. The first to fourth concave portions 101′, 102′, 103′, and 104′ may be formed by, for example, an ion beam or etching process.

Referring back to FIG. 3B, diameters “r” of the first to fourth concave portions 101′, 102′, 103′, and 104′ may be randomly formed. The diameters “r” of the first to fourth concave portions 101′, 10 103′, and 104′ may be equal to or less than about 10 μm. For example, the diameters “r” of the first to fourth concave portions 101′, 102′, 103′, and 104′ may be in a range from about 0.01 μm to about 10 μm.

A depth “d” of the first to fourth concave portions 101′, 102′, 103′, and 104′ may be substantially the same as a thickness “T” of the flexible film 100. Accordingly, the first to fourth concave portions 101′, 102′, 103′, and 104′ may penetrate the flexible film 100.

Arrangement of the first to fourth concave portions 101′, 102′, 103′, and 104′ may be irregular. For example, the number of first to fourth concave portions 101′, 102′, 103′, and 104′ may be 1 billion or more per unit area of 1 cm². By irregularly arranging the first to fourth concave portions 101′, 102′, 103′, and 104′, a process restriction may be reduced, and a defect ratio may be reduced. Moreover, when defects occur a process of forming the first to fourth concave portions 101′, 102′, 103′, and 104′, a repair process may be easily performed since there is substantially low design restriction.

Referring to FIG. 12, first color conversion portions 210 are formed in the corresponding first concave portions 101′ of the first pixel area PA1. Since the first concave portions 101′ are island types and are separated from each other, the first color conversion portions 210, which are formed in the corresponding first concave portions 101′, are also island types, and thus, are separated from each other.

The first color conversion portions 210 may include the first metal particles of a nanoscale, as previously illustrated with reference to FIG. 4. The first metal particles may convert light incident onto the first color conversion portions 210 to blue light, according to the plasmon phenomenon. The material and shape of the first metal particles are the same as those of the first color conversion portions 210 illustrated with reference to FIG. 4. The respective first color conversion portions 210 may alternatively further include quantum dots. The quantum dots may be substantially the same as previously described above with reference to FIG. 4.

Referring to FIG. 13, second color conversion portions 220 are formed in the corresponding second concave portions 102′ of the second pixel area PA2. Since the second concave portions 102′ are island types separated from each other, the second color conversion portions 220 formed in the corresponding second concave portions 102′ are also island types, and thus, are separated from each other.

The second color conversion portions 220 may include the second metal particles of a nanoscale, as previously illustrated with reference to FIG. 5. The second metal particles may convert light incident onto the second color conversion portions 220 to green light, according to the plasmon phenomenon. The material and shape of the second metal particles are the same as those of the second color conversion portions 220 illustrated with reference to FIG. 5. The respective second color conversion portions 220 may alternatively further include a quantum dots. The quantum dots may be substantially the same as previously described above with reference to FIG. 5.

Referring to FIG. 14, third color conversion portions 230 are formed in the corresponding third concave portions 103′ of the third pixel area PA3. Since the third concave portions 103′ are island types separated from each other, the third color conversion portions 230 formed in the corresponding third concave portions 103′ are also island types, and thus, are separated from each other.

The third color conversion portions 230 may include the third metal particles of a nanoscale, as previously illustrated with reference to FIG. 6. The third metal particles may convert light incident onto the third color conversion portions 230 to red light, according to the plasmon phenomenon. The material and shape of the third metal particles are the same as those of the third conversion portions 230 illustrated with reference to FIG. 6. The respective third color conversion portions 230 may alternatively further include quantum dots. The quantum dots may be substantially the same as previously described above with reference to FIG. 6.

Referring to FIG. 15, light blocking portions 240 are formed in the corresponding light blocking concave portions 104′ of the light blocking area BA. The light blocking portions 240 may include carbon black or a mixture of the first, second, and third metal particles. The light blocking portions 240 may be formed by using a coating process or a printing process. Thereafter, the flexible color filter 50C is separated from the carrier substrate C.

As illustrated in FIG, 15, since the flexible color filter 50C includes the first to third color conversion portions 210, 220, and 230 within the flexible film 100, the flexible color filter 50A may have substantially the same thickness as the flexible film 100. Since the first to fourth concave portions 101′, 102′, 103′, and 104′ are formed in the flexible film 100, the flexible color filter 50C may be bendable as illustrated in FIG. 8. In addition, since the color conversion is performed by using metal particles, degradation of color reproducibility may be prevented, when the flexible color filter 50C is exposed to light or heat for a long period of time.

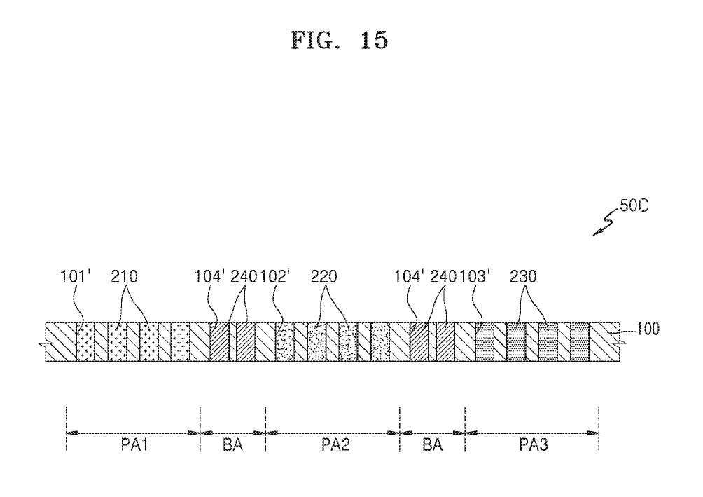

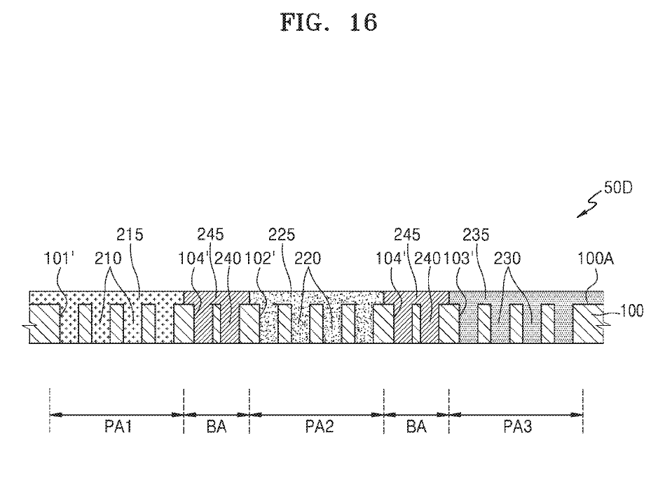

FIG. 16 is a cross-sectional view illustrating a flexible color filter 50D according to an exemplary embodiment of the present invention.

Referring to FIG. 16, the flexible color filter 50D is similar to the flexible color filter 50C FIGS. 10 through 15, except for first, second, and third extended color conversion portions 215, 225, and 235. Therefore, repeated descriptions of the substantially similar elements will be omitted, and the differences will be explained hereinafter.

In the first pixel area PA1, the first extended color conversion portion 215 is disposed on the first side 100A of the flexible film 100, and connect the first color conversion portions 210 to each other. The first extended color conversion portions 215 may include the same material as the first color conversion portions 210. The first extended color conversion portion 215 may be formed together with the first color conversion portions 210 during a process of forming the first color conversion portions 210.

In the second pixel area PA2, the second extended color conversion portion 225 may be disposed on the first side 100A of the flexible film 100, and connect the second color conversion portions 220 to each other. The second extended color conversion portion 225 may include the same material as the second color conversion portions 220. The second extended color conversion portion 225 may be formed together with the second color conversion portions 220 during a process of forming the second color conversion portions 220.

In the third pixel area PAS, the third extended color conversion portion 235 may be disposed on the first side 100A of the flexible film 100, and connect the third color conversion portions 230 to each other. The third extended color conversion portion 235 may include the same material as the third color conversion portions 230.. The third extended color conversion portion 235 may be formed together with the third color conversion portions 230 during a process of forming the third color conversion portions 230.

In the light blocking area BA, an extended light blocking portion 245 may be disposed on the first side 100A of the flexible film 100 and connect the light blocking portions 240, which are disposed within the corresponding light blocking concave portions 104′ and are separated from each other. The extended light blocking portion 245 may include the same material as the light blocking portions 240. The extended light blocking portion 245 may be formed together with the light blocking portions 240 during a process of forming the light blocking portions 240.

As described above, light passing through a bulk of the flexible film 100 between the first, second, and third concave portions 101, 102, and 103, that is, light which is not converted by the first, second, and third color conversion portions 210, 220, and 230, may be converted by the corresponding first, second, and third extended color conversion portions 215, 225, and 235.

The flexible color filters 50A, 50B, 50C, and 50D according to exemplary embodiments of the present invention illustrated with reference to FIGS. 2 through 16 may be utilized in the display device 1A of FIG. 1, such as, an organic light-emitting display device and a liquid crystal display device.

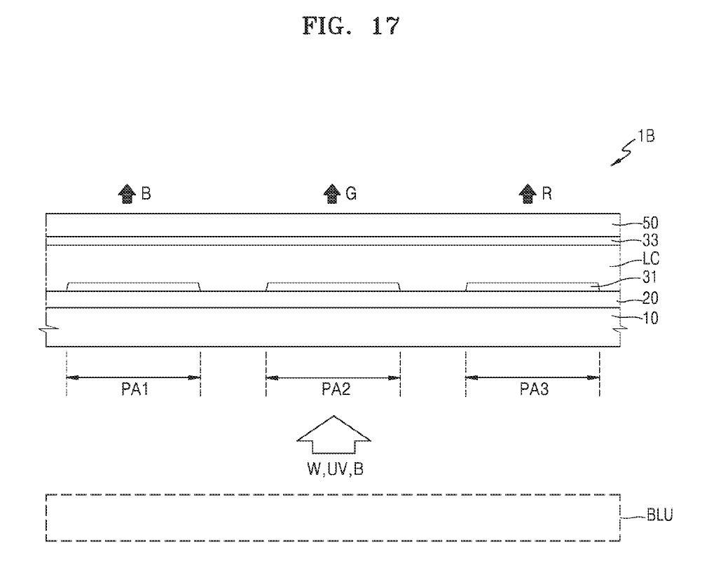

FIG. 17 is a cross-sectional view illustrating a display device according to an exemplary embodiment of the present invention.

Referring to FIG. 17, a display device 1B is a liquid crystal display device and may include a pixel electrode 31, an opposite electrode 33, and a liquid crystal (LC) layer disposed between the pixel electrode 31 and the opposite electrode 33. The pixel electrode 31 of each of pixel areas PA1, PA2, and PA3 is electrically connected to a pixel circuit (not shown) arranged in a circuit layer 20.

A flexible color filter 50 converts light passing through the LC layer. According to an exemplary embodiment of the present invention, white light W, ultraviolet light UV, or blue light B is emitted from a back light unit (BLU), passes through the LC layer, proceeds toward the flexible color filter 50, and may be converted into blue, green, and red light by passing through the flexible color filter 50.

When the BLU emits the blue light B, color purity may be improved by using the flexible color filter 50B or 50D illustrated with reference to FIGS. 9 and 16, as compared to using the flexible color filter 50A or 50C illustrated with reference to FIG. 7 and. 15.

When the BLU emits the blue light B, the color purity may be improved when the second and third color conversion portions 220 and 230 of the second and third pixel areas PA2 and PA3, which correspond to a green pixel and a red pixel, include the metal particles and the quantum dots.

Although certain exemplary embodiments and implementations have been described herein, other embodiments and modifications will be apparent from this description. Accordingly, the inventive concept is not limited to such exemplary embodiments, but rather to the broader scope of the presented claims and various obvious modifications and equivalent arrangements.

What is claimed is:

1. A flexible color filter, comprising:
a flexible film comprising a first side and a second side opposite to the first side, the flexible film comprising first concave portions disposed in the first side of the flexible film; and
first color conversion portions respectively disposed in the first concave portions,
wherein:
the flexible film comprises a first pixel area and a second pixel area adjacent to the first pixel area;
the first concave portions are disposed in the first pixel area; and
each of the first color conversion portions comprises a first metal particle.

2. The flexible color filter of claim 1, further comprising:
second concave portions disposed in the first side of the flexible film in the second pixel area; and
second color conversion portions respectively disposed in the second concave portions, each of the second color conversion portions comprising a second metal particle.

3. The flexible color filter of claim 2, wherein at least one of a shape and a size of the second metal particle is different from that of the first metal particle.

4. The flexible color filter of claim 3, wherein at least one of the first color conversion portions and the second color conversion portions further comprises a quantum dot.

5. The flexible color filter of claim 1, wherein the first metal particle comprises at least one of gold (Au), copper (Cu), and aluminum (Al).

6. The flexible color filter of claim 1, further comprising:
a first extended color conversion portion disposed on the first side of the flexible film and connecting the first color conversion portions to each other, the first extended color conversion portion comprising the first metal particle.

7. The flexible color filter of claim 1, wherein the flexible film comprises a transparent resin material.

8. The flexible color filter of claim 1, wherein a depth of each of the first concave portions is equal to or less than a thickness of the flexible film.

9. The flexible color filter of claim 1, wherein the flexible film further comprises:
a light blocking area disposed between the first pixel area and the second pixel area;
a light blocking concave portion disposed in the first side of the flexible film in the light blocking area; and
a light blocking material disposed in the light blocking concave portion.

10. A method of manufacturing a flexible color filter, the method comprising:
preparing a flexible film comprising a first side and a second side opposite to the first side, the flexible film comprising a first pixel area and a second pixel area;
forming first concave portions in the first pixel area of the flexible film; and
forming first color conversion portions in the first concave portions, respectively, each of the first color conversion portions comprising a first metal particle.

11. The method of claim 10, further comprising:
forming second concave portions in the first side of the flexible film in the second pixel area.

12. The method of claim 11, wherein forming the first concave portions and the second concave portions comprise the same process.

13. The method of claim 11, further comprising:
forming second color conversion portions in the second concave portions, respectively, each of the second color conversion portions comprising a second metal particle,
wherein at least one of a shape and a size of the second metal particle is different from that of the first metal particle.

14. The method of claim 13, wherein at least one of the first color conversion portions and the second color conversion portions further comprises a quantum dot.

15. The method of claim 10, wherein the first metal particle comprises at least one of gold (Au), copper (Cu), and aluminum (Al).

16. The method of claim 10, further comprising:
forming a first extended color conversion portion on the first side of the flexible film, the first extended color conversion portion comprising the first metal particle and connecting the first color conversion portions to each other,
wherein forming the first extended color conversion portion and the first color conversion portions comprise the same process.

17. The method of claim 10, wherein the flexible film comprises a transparent resin material.

18. The method of claim 10, wherein a depth of each of the first concave portions is equal to or less than a thickness of the flexible film.

19. The method of claim 10, further comprising:
disposing a carrier substrate on the second side of the flexible film.

20. The method of claim 10, further comprising:
forming a light blocking concave portion in the first side of the flexible film in a light blocking area between the first pixel area and the second pixel area; and
forming a light blocking portion in the light blocking concave portion, the light blocking portion comprising a light blocking material,
wherein forming the light blocking concave portion and the first concave portions comprises the same process.
